(19) United States
(12) Patent Application Publication
(10) Pub. No.: US 2012/0032915 A1
(43) Pub. Date: Feb. 9, 2012

(54) OPERATING ELEMENT FOR ACTUATION BY A USER AND OPERATING ELEMENT MODULE

(75) Inventor: Marten WITTORF, Ingelheim (DE)

(73) Assignee: GM GLOBAL TECHNOLOGY OPERATIONS LLC, Detroit, MI (US)

(21) Appl. No.: 13/198,798

(22) Filed: Aug. 5, 2011

(30) Foreign Application Priority Data
Aug. 5, 2010 (DE) 102010033514.2

(51) Int. Cl. G06F 3/045; G06K 11/06; G06F 3/041

(52) U.S. Cl. 345/174; 345/173; 178/18.01

(57) ABSTRACT

An operating element for actuation by a user includes, but is not limited to a movable element that can be actuated by a user and a sensor layer, which is situated below the movable element and implemented as a touchscreen, the sensor layer being implemented to establish an actuation of the movable element.

### CROSS-REFERENCE TO RELATED APPLICATION

This application claims priority to German Patent Application No. 102010033514.2, filed Aug. 5, 2010, which is incorporated herein by reference in its entirety.

### TECHNICAL FIELD

The technical field relates to an operating element for actuation by a user. Furthermore, the technical field relates to an operating element module, in particular for use in a motor vehicle.

### BACKGROUND

In recent years, operating elements implemented as touchscreens have increasingly gained significance. They have the advantage of an appealing appearance and a smooth, easy-to-clean surface. They allow an almost arbitrary number of switch functions to be housed on a single sensor film, which greatly reduces the production expenditure.

In order to allow more differentiated inputs, situating a mechanical switch under a touchscreen was proposed in US 2008/0024958 A1. In this way, the touchscreen can be equipped with a three-dimensional sensitivity. Because of their smooth surface, touchscreens typically give the user no clear feedback about whether and which function was actuated.

For many applications, for example, with operating elements, which are housed in the central console of a vehicle, for an audio system, an HVAC (heating, ventilation, and air-conditioning) system, a hazard-warning and turn-signal system, electrical power window controls, and further operating elements, it would be desirable to emphasize at least some of the switch functions and equip them with feedback for the user.

At least one object is therefore to specify an operating element which is operable in a manner that is comfortable and intuitive for the user and simultaneously has the advantages of a touchscreen. In addition, other objects, desirable features and characteristics will become apparent from the subsequent summary and detailed description, and the appended claims, taken in conjunction with the accompanying drawings and this background.

### SUMMARY

An operating element is provided for actuation by a user, the operating element comprising a movable element, which can be actuated by a user, and a sensor layer, which is situated below the movable element and is implemented as a touchscreen. The sensor layer is implemented to establish an actuation of the movable element. An operating element is therefore provided, which unifies aspects of a typical operating element with those of a touchscreen. The operating element is very similar in haptics to typical operating elements. The operation is designed for the user in a similar way using rotating knob, button, rocker switch, pushbutton, or similar means and the user, by feeling the movable element and its intentional movement, receives direct feedback of its actuation. The movable element additionally identifies the operating element in a number of further operating elements on a touchscreen, and singles it out, so that it is easy to find and also is solely to be felt.

The operating element therefore has the advantage that it is intuitive and comfortable to operate. However, advantages of touchscreen technology can simultaneously be used, in that a large number of operating elements, several of which are equipped with movable elements and others of which are implemented solely as touchscreen elements, can be applied to a single sensor film and produced jointly. The sensor layer can be implemented as a resistive or as a capacitive touchscreen.

In one embodiment, the touchscreen has at least one pressure sensor, the movable element being able to have an area which exerts pressure on the sensor layer in the actuated state of the movable element. In such pressure sensors, which can be implemented as both resistive and also capacitive, either electrically conductive layers are connected at points by pressure or two layers of a capacitor are brought close to one another, whereby the capacitance of the capacitor changes measurably.

Alternatively, the touchscreen can also have at least one proximity sensor, if it is implemented as a capacitive touchscreen. With this principle, the change of a capacitance of a capacitor or capacitor system is measured, which results because of the approach of a trigger element (also referred to as a switching flag). The trigger element can be implemented as a metallic or nonmetallic element, for example, however, the finger of a user can also be used as the trigger element. In this case, the movable element has a trigger element for changing the capacitance of a capacitor of the proximity sensor. This embodiment has the advantage that rotating knobs can also be used as the movable elements, whose rotational axis is perpendicular to the touchscreen, since with suitable configuration of the trigger element, an angle of the movable element can be recognized.

Depending on the embodiment of the movable element and the sensor layer, the movable element can be able to be actuated by rotating, pushing, and/or pulling. The operating element can, for example, be implemented as a volume control or tuning button of an audio system, as a controller of an HVAC (heating, ventilation, and air conditioning) system, or can be provided for actuating a hazard-warning and turn-signal system of a vehicle. These functions are frequently used in a motor vehicle, so that their comfortable operation and easy location is of particular advantage.

According to an embodiment, the operating element is used in a vehicle, in particular in the operating element module (“faceplate”) of the central console. According to an embodiment, an operating element module is provided, which has a large-area sensor layer having a number of operating elements implemented as touch sensors and a number of the described operating elements having movable elements. The operating element module has the advantage that a touchscreen can be provided for the majority of the operating elements, which is producible particularly simply and cost-effectively, while individual functions can be singled out using special operating elements, which are particularly comfortable to actuate.

The operating element module has the further advantage that design and function changes can typically be reacted to very flexibly, since the touchscreen can be changed relatively simply in production. Special variants and customer-specific wishes can be implemented easily for almost all operating elements in this way, the haptics of a “real” button not having to be omitted simultaneously for selected operating elements.

### BRIEF DESCRIPTION OF THE DRAWINGS

The present invention will hereinafter be described in conjunction with the following drawing figures, wherein like numerals denote like elements, and:

FIG. 1 is schematically shows an operating element module for a vehicle according to an embodiment;

FIG. 2a is schematically shows an operating element module according to a first embodiment in the non-actuated state;

FIG. 2b is schematically shows the operating element according to FIG. 2a in the actuated state;

FIG. 3a is schematically shows an operating element according to a second embodiment in a first actuation state; and

FIG. 3b is schematically shows the operating element according to FIG. 3a in a second actuation state.

### DETAILED DESCRIPTION

The following detailed description is merely exemplary in nature and is not intended to limit application and uses. Furthermore, there is no intention to be bound by any theory presented in the preceding background or summary or the following detailed description.

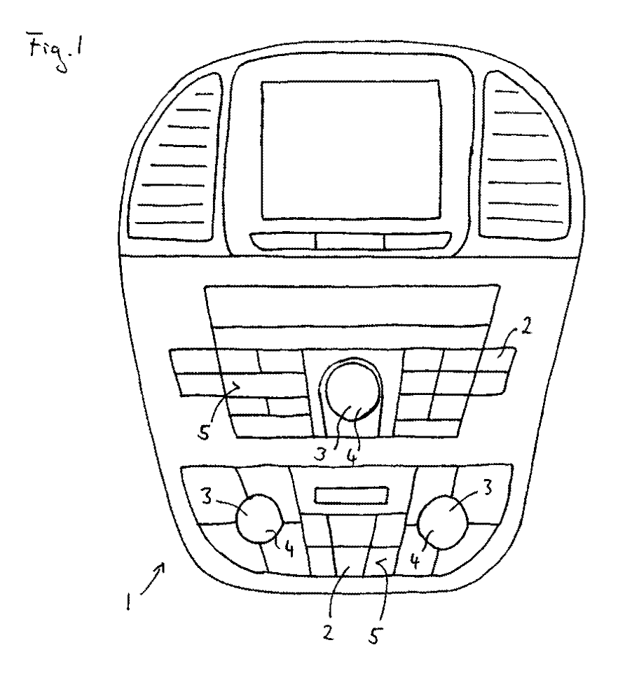

FIG. 1 shows an operating element module 1 to be situated in the central console of a vehicle, via which an infotainment system (for example, audio system and navigation system), an HVAC system, and various further functions of the vehicle such as the hazard-warning and turn-signal system can be operated. For this purpose, the operating element module 1 has a large number of first operating elements 2, which are implemented as segments of one or more touchscreens 5. The touchscreen 5 has a capacitive sensor layer.

Furthermore, the operating element module 1 has a number of second operating elements 3, which are implemented in the embodiment shown as the volume control and tuning button of an audio system and as a controller for an HVAC system. The second operating elements 3 each have a movable element 4, which is implemented as a rotating knob. The movable element is situated above the touchscreen 5, i.e., the touchscreen 5 is situated not only in the area of the first operating elements 2, but rather also in the area of the second operating elements 3.

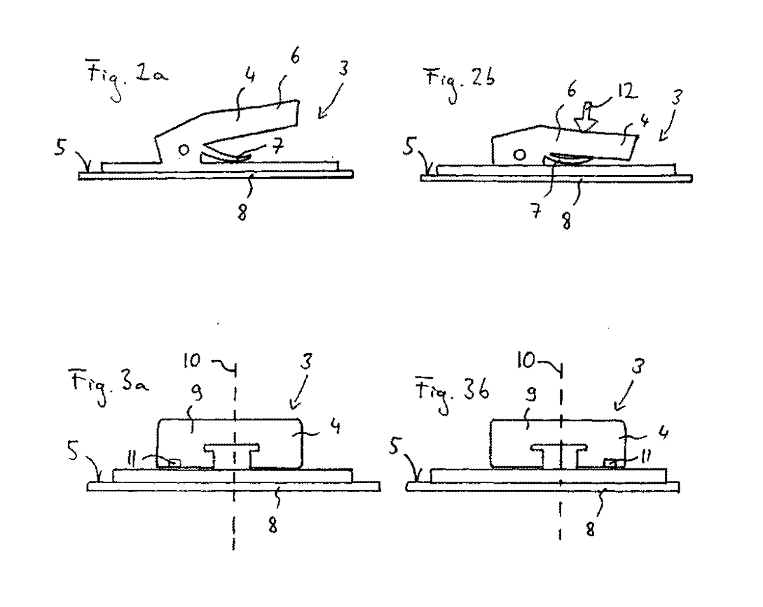

FIG. 2a shows a first embodiment of the second operating element 3 schematically in cross-section. In this embodiment, the movable element 4 of the operating element 3 is implemented as a button 6, which can be actuated against a force provided by a spring element 7 by pressing. The movable element 4 is situated on the sensor layer 8, which is implemented as a touchscreen 5. The area of the sensor layer 8 under the movable element 4 represents a separate segment of the touchscreen 5, in which an actuation of the button 6 can be established.

FIG. 2b shows the operating element 3 according to FIG. 2a in an actuated position, into which it was moved by exerting a pressure in the direction of the arrow 12. In the actuated position, the ground of the button 6 is brought close to the sensor layer 8. The sensor layer 8, which is implemented as a capacitive proximity sensor, establishes the change of the electrical field thus caused, the sensor layer 8 operating with an RC oscillator. The capacitance between an active electrode of the sensor layer 8 and the electrical ground potential is measured.

The capacitance increases due to the approach of the button 6 to the sensor layer 8 and thus influences the oscillation amplitude of the RC oscillator. A trigger stage connected downstream from the RC oscillator is thus tilted and an actuation of the button 6 is recognized. The haptic feedback which the user receives upon the actuation can be influenced in particular by the selection of the spring element 7. In an embodiment which is not shown, the sensor layer 8 has a capacitive pressure sensor instead of the proximity sensor, which establishes the pressure by the button 6 or the spring element 7 against the surface of the sensor layer 8.

FIG. 3a schematically shows a second embodiment of the second operating element 3 in a first actuation state. In this embodiment, the operating element 3 is implemented as a rotating knob 9, which is rotatable around the axis 10 during the actuation. A trigger element 11 is incorporated in the rotating knob 9, whose location is used to establish the rotational angle. A sensor layer 8 having capacitive proximity sensors is also situated below the operating element 3 of the second embodiment.

FIG. 3b schematically shows the operating element 3 according to FIG. 3a in a second actuation state. In this actuation state, the rotating knob 9 was rotated by approximately 180°. The angle of the trigger element thus changed causes a change of the capacitance, the capacitance locally decreasing or increasing during the movement of the trigger element 11. The rotation of the rotating knob 9 is established by this shift of the capacitance. The haptic feedback which the user receives during the actuation can be influenced by the provision of appropriate friction during rotation of the rotating knob 9.

In addition, in this embodiment and the embodiment described on the basis of FIGS. 2a and FIG. 2b, optical or acoustic feedback can also be provided by a light signal or a beeping sound.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. An operating element for an actuation by a user, comprising:
a movable element configured for the actuation by the user; and
a sensor layer that is situated below the movable element and is implemented as a touchscreen, the sensor layer configured to establish the actuation of the movable element.

2. The operating element according to claim 1, wherein the sensor layer is a resistive touchscreen.

3. The operating element according to claim 1, wherein the sensor layer is a capacitive touchscreen.

4. The operating element according to claim 3, wherein the touchscreen comprises at least one pressure sensor.

5. The operating element according to one of claim 2, wherein the movable element has an area that exerts pressure on the sensor layer in an actuated state of the movable element.

6. The operating element according to claim 3, wherein the capacitive touchscreen comprises at least one proximity sensor.

7. The operating element according to claim 6, wherein the movable element comprises a trigger element configured to change a capacitance of a capacitor of the at least one proximity sensor.

8. The operating element according to claim 1, wherein the movable element is actuated by rotating.

9. The operating element according to claim 1, wherein the movable element is actuated by pressing.

10. The operating element according to claim 1, wherein the movable element is actuated by pulling.

11. The operating element according to claim 1, wherein the operating element is a volume controller of an audio system.

12. The operating element according to claim 1, wherein the operating element is a tuning button of an audio system.

13. The operating element according to claim 1, wherein the operating element is a controller of an HVAC system.

14. The operating element according to claim 1, wherein the operating element is configured to actuate a hazard-warning and turn-signal system of a vehicle.
